(19) United States
(12) Patent Application Publication
(10) Pub. No.: US 2025/0111723 A1
(43) Pub. Date: Apr. 3, 2025

(54) METHOD AND SYSTEM FOR AREA-BASED ACCESS CONTROL

(71) Applicant: Konica Minolta Business Solutions U.S.A., Inc., Ramsey, NJ (US)

(72) Inventor: Rahul SURAPARAJU, Fremont, CA (US)

(73) Assignee: Konica Minolta Business Solutions U.S.A., Inc., Ramsey, NJ (US)

(21) Appl. No.: 18/478,407

(22) Filed: Sep. 29, 2023

(51) Int. Cl. G07C 9/37; G06V 20/52; G06V 40/16; G08B 13/196

(52) U.S. Cl. CPC G07C 9/37; G06V 20/52; G06V 40/172; G08B 13/19613; G07C 2209/02

(57) ABSTRACT

A method, a non-transitory computer readable medium, and an identify and management device for area-based access control. The method includes receiving, by a first computer system, data associated with one or more users within one or more zones, the data associated with the one or more users within the one or more zones including facial recognition data; determining, by the first computer system, based on the received facial recognition data if the one or more users are permitted within the one or more zones; and generating, by the first computer system, a response as to a presence of the one or more users within the one or more zones.

### FIELD OF THE DISCLOSURE

The present disclosure generally relates to a method and system for area-based access control, and more particularly, to a method and system for generating a virtual security wall through a seamless zone and area-based access control system that provides physical-area granularity on access control for a video surveillance system.

### BACKGROUND

Today's video surveillance based security solutions (legacy as well as modern and intelligent ones) apply the video surveillance at flat-level and lacks granular control capabilities, meaning the “area-under-coverage” by cameras is considered as one whole area. The surveillance based security solutions do not provide for if a person is allowed in one physical area or zone (i.e., physical area 1 or zone 1) but not allowed in adjacent physical area or zone (i.e., physical area 2 or zone 2). For example, only some designated personnel at pharmacy may be allowed in relatively high security area, for example, in a pharmacy where substance-related drugs are kept. The current solutions do provide some form of tracking and tracking capabilities that are manual and rudimentary.

### SUMMARY

In consideration of the above issues, a method and system for area-based access control that generates a virtual security wall through a seamless zone and area-based access control system that provides physical-area granularity on access control for a video surveillance system.

In accordance with one aspect, a method for area-based access control, the method comprising: receiving, by a first computer system, data associated with one or more users within one or more zones, the data associated with the one or more users within the one or more zones including facial recognition data; determining, by the first computer system, based on the received facial recognition data if the one or more users are permitted within the one or more zones; and generating, by the first computer system, a response as to a presence of the one or more users within the one or more zones.

In accordance with another aspect, a non-transitory computer-readable storage medium having program instructions embodied therewith, the program instructions executable by a computer to cause the computer to perform a process for area-based access control, comprising: receiving data associated with one or more users within one or more zones, the data associated with the one or more users within the one or more zones including facial recognition data; determining based on the received facial recognition data if the one or more users are permitted within the one or more zones; and generating a response as to a presence of the one or more users within the one or more zones.

In accordance with a further aspect, an identify and management device comprising: a processor configured to: receive data associated with one or more users within one or more zones, the data associated with the one or more users within the one or more zones including facial recognition data; determine based on the received facial recognition data if the one or more users are permitted within the one or more zones; and generate a response as to a presence of the one or more users within the one or more zones.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for generating a virtual security wall through a seamless zone and area-based access control system that provides physical-area granularity on access control for a video surveillance system. in accordance with an exemplary embodiment.

FIG. 2 is an illustration of another system for generating a virtual security wall through a seamless zone and area-based access control system that provides physical-area granularity on access control for a video surveillance system with advanced automated tracking and tracking abilities in accordance with an embodiment.

FIG. 3 is an illustration of an automated instantaneous area heat map in accordance with an exemplary embodiment.

FIG. 4 is a flowchart for a method for generating a virtual security wall through a seamless zone and area-based access control system that provides physical-area granularity on access control for a video surveillance system in accordance with an embodiment.

FIG. 5 is an illustration of an exemplary hardware architecture for an embodiment of a computer system for a video surveillance system.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

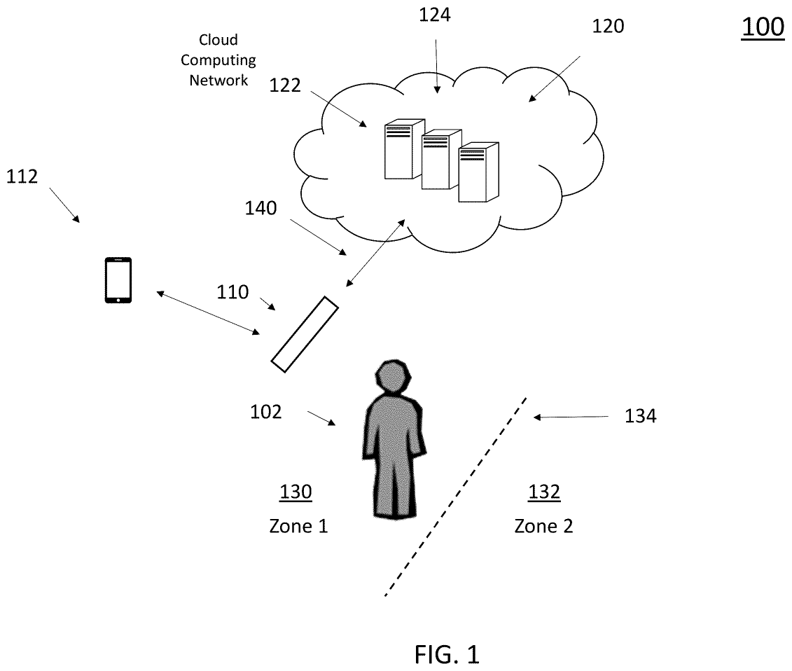

FIG. 1 is an illustration of a system 100 for generating a virtual security wall through a seamless zone and area-based access control system that provides physical-area granularity on access control for a video surveillance system. in accordance with an exemplary embodiment. As shown in FIG. 1, the system 100 can include one or more video surveillance cameras 110 and one or more computer systems 112, 120. The system 100 can also include one or more users 102 that are able to enter one or more zones 130, 132. The one or more users 102 can include, for example, employees of a company that have been onboard (registered) to the system 100 via, for example, a facial recognition system, for example, preferably a facial recognition solution with artificial intelligence (AI) that can be used to identify the one more users 102 from an image or video. In accordance with an embodiment, the facial recognition solution with artificial intelligence (AI) can use a combination of techniques including deep learning, computer vision algorithms, and image processing to identify and track the one or more users 102. In accordance with an embodiment, the one or more users 102 can include, for example, individual (i.e., humans), objects (i.e., valuables such as art and the like), animals, and the like.

In accordance with an embodiment, each of the one or more zones 130, 132 can be monitored by one or more video surveillance cameras 110. Alternatively, the one or more zones 130, 132 can be monitored by a single video surveillance camera 110.

In accordance with an embodiment, the one or more video surveillance cameras 110 can be an indoor video surveillance camera, an outdoor video surveillance camera, or an indoor/outdoor surveillance camera that can monitor an entire room or space without any blind spots. In addition, the one or more video surveillance cameras 110 can be configured, for example, to be operated via a computer system 112, which can be a personal computer (PC), a tablet or smartphone browser.

The one or more computer systems 112, 120 can include a processor or central processing unit (CPU), and one or more memories for storing software programs and data. The processor or CPU carries out the instructions of a computer program, which operates and/or controls at least a portion of the functionality of the devices the one or more computer systems 112, 120. The one or more computer systems 112, 120 can also include an operating system (OS), which manages the computer hardware and provides common services for efficient execution of various software programs. In accordance with an embodiment, the one or more computer systems 120 can be a cloud computing network 122 that includes a plurality of computer systems 124.

The one or more video surveillance cameras 110 and the one or more computer systems 112, 120 can be connected via a communication network 140. The communication network 140 may include, for example, a conventional type of network, wired or wireless, and may have any number of configurations, such as a star configuration, token ring configuration, or other known configurations. The communication network 140 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

Data may be transmitted in encrypted or unencrypted form between the one or more video surveillance cameras 110 and the one or more computer systems 112, 120 using a variety of different communication protocols including, for example, various Internet layer, transport layer, or application layer protocols. For example, data may be transmitted between the one or more video surveillance cameras 110 and the one or more computer systems 112, 120 via the network 140 using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), file transfer protocol (FTP), WebSocket (WS), wireless access protocol (WAP), various messaging protocols (SMS, MMS, XMS, IMAP, SMTP, POP, WebDAV, etc.), or other known protocols.

As shown in FIG. 1, the system 100 can generating a virtual security wall 134 through a seamless zone and area-based access control system that provides physical-area granularity on access control for a video surveillance system with advanced automated tracking and tracking abilities. For example, as shown in FIG. 1, the one or more users 102 can be in a first zone (i.e., Zone 1) 130, which can be an authorized area or zone for the one or more users 102. However, if the one or more users 102 enters into a second zone (i.e., Zone 2) 132, the system 100 can be designed to send an alert, for example, a visual or audible alert, that the one or more users 102 have entered into an unauthorized zone (i.e., the second zone 132). In view of the above, the system 100 can be configured to provide a virtual security wall 134 through seamless zones 130, 132 in which an area-based access control solution is provided that provides physical-area granularity for video surveillance solutions. In accordance with an embodiment, the seamless zones 130, 132 do not need to have a physical barrier that separates the zones 130, 132. For example, the zones 130, 132 can be separate parts of an office, supply room, or storage room without physical barriers.

In accordance with an embodiment, the area abstraction approach offers a solution that includes granular security, easier and automated tracking and tracking, and an area heat map that provides visibility to a location of one or more users 102. In addition, the method for generating a virtual security wall through a seamless zone and area-based access control system that provides physical-area granularity on access control for a video surveillance system 100 can provide advanced granular security by providing an end to end solution that is seamless and automated. For example, the system 100 can builds the virtual security wall 134, which provides customers of the video surveillance solutions as disclosed herein can have more peace of mind on several aspects of physical access security by the one or more users (i.e., employees) 102 on the constant-move and their customers (i.e., any person that is not a registered employee can be considered as a non-employee).

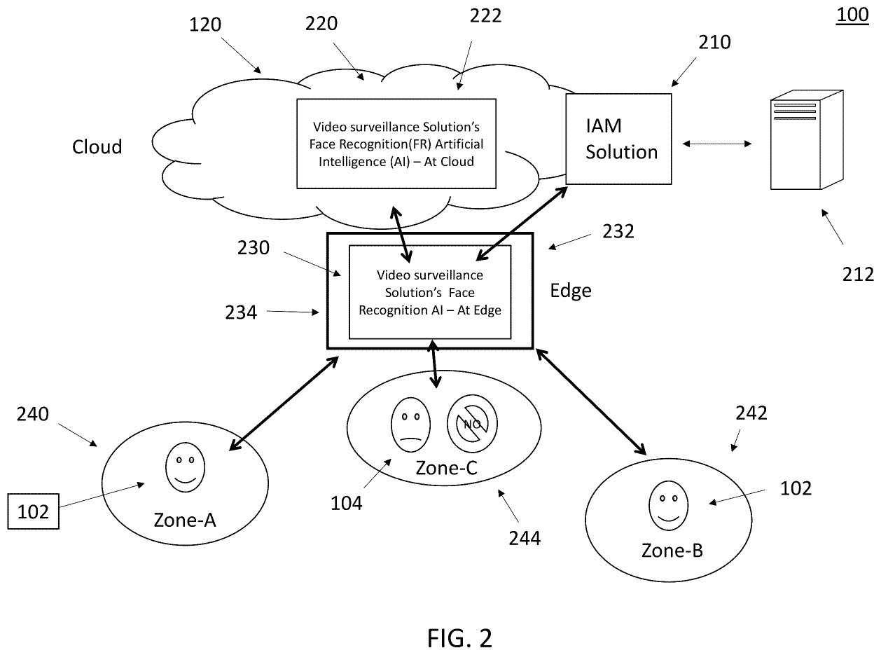

FIG. 2 is another illustration of the system 100 for generating a virtual security wall through a seamless zone and area-based access control system that provides physical-area granularity on access control for a video surveillance system with advanced automated tracking and tracking abilities in accordance with an embodiment. As shown in FIG. 2, the system 200 can include an identify and management solution 210, and a cloud computing network 120 configured with a video surveillance solution 220, and/or an edge solution having a video surveillance solution 230. The video surveillance solutions 220, 230, can be, for example, facial recognition (FR) solutions with artificial intelligence (AI) 222, 232 that can be trained to learn features of the one or more users 102.

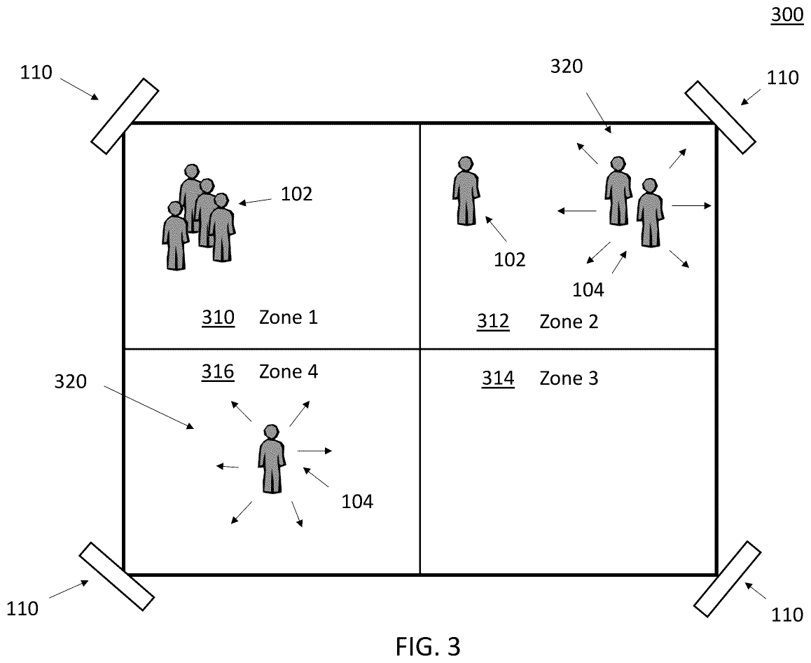

In accordance with an embodiment, the identify and management solution (IAM) 210 can be hosted, for example, in the cloud computing network 122, on an edge device 234 that includes the video surveillance solution 230, or on a separate computer system 212. The identify and management solution 210 can configured to allow an administrator to assign allowed/denied zones and/or area affinities to each of the one or more users 102. For example, the video surveillance solutions 220, 230 with the facial recognition solution with artificial intelligence (AI) can provide the username of a user 102, and the origin of the surveillance camera 110 (for example, a media access control (MAC) address of the surveillance camera 110), and the identify and management solution 210 can check area affinity, and if the one or more users 102 are not allowed in the area, the identify and management solution 210 can send an alert and/or an update 310 on a map 300 (FIG. 3), for example, an alert heat map.

In accordance with an embodiment, the facial recognition solution with artificial intelligence 222, 232 can be configured to execute a series of steps that includes facial detection (i.e., face detection) of the one or more users 102, facial extraction (i.e., face extraction) of the one or more users 102 from the video images from the video surveillance cameras 110, and facial matching (i.e., face matching) of the one or more users 102. In accordance with an embodiment, the facial recognition solution with artificial intelligence 222, 232 can initially confirm the presence of faces as they appear on a live surveillance cameras feed, a video recording or as the facial recognition system 220, 230 scans the captured still image. The entire field of view can be scanned for any area containing full or even partial human faces. After face detection, the facial recognition system 220, 230, for example, the facial recognition solution with artificial intelligence 222, 232, can extract a template from the facial image and a matching or searching for a face of the one or more users 102 can be performed.

In accordance with an embodiment, the facial recognition solution with artificial intelligence 222, 232, can perform a facial match, if the one or more users 102 are enrolled or onboarded into a database for the facial recognition solution with artificial intelligence 222, 232. Alternatively, if the one or more users 102 have not been enrolled or onboarded into the database for the facial recognition solution with artificial intelligence 222, 232, the facial recognition solution with artificial intelligence 222, 232 can generate or assign the user 102 an identity that can be used for the current and/or optionally future identification of the user 102.

In accordance with an embodiment, the facial recognition solution with artificial intelligence 232 can deployed at the edge, for example, embedded in an edge device 234, for example, a computer system, on the premises of the one or more video surveillance cameras 110. Alternatively, the facial recognition solution with artificial intelligence 222 can be located, for example, on a computer system 120, for example, in a cloud computing network 122.

In accordance with an embodiment, the facial recognition solution with artificial intelligence 222, 232 includes an artificial intelligence component that allows the facial recognition solution to process data to recognize the one or more users 102. The artificial intelligence component of the facial recognition system 220, 230, preferably includes a machine learning component.

In accordance with an embodiment, the system 100 can introduce advanced automated tracking and tracking capabilities into video surveillance based solutions using an area abstraction approach. For example, the area-level abstraction approach can make tracking of the one or more users 102 and non-users 104 (FIG. 3) relatively easy, compared to camera based tracking solution. For example, the system 100 can be used for tracking a customer of a business or store that enters a prohibit zone, the incident can be brought immediately to a security personnel relatively easier and quicker since the system 100 is automated rather than merely monitoring movement of individuals with one or more zones.

In addition, the method and system for generating a virtual security wall through a seamless zone and area-based access control system that provides physical-area granularity on access control for a video surveillance system can provide for area-based maps (or heat maps) 300 as shown in FIG. 3 that provide for a visualization capability that helps a security personal better coordinate with employees the movements within a plurality of zones that one or more employees, for example, may be restricted or prohibited from entering.

In accordance with an embodiment, the one or more users 102 can be onboarded into the system 100. During the onboarding process (or registration) of the one or more users 102, each of the one or more users 102 can have defined zones 130, 132 in which the one or more users 102 can access, and optionally, one or more zones 130, 132 that the one or more users 102 cannot access. In accordance with an embodiment, the system 100 can be configured to pre-populate specific coverage areas in which the one or more users 102 are allowed access. For example, for a store or business, any area in which non-user 104 (i.e., customers) can be auto populated to allow the one or users 102 (i.e., employees) such that the one or more users 102 are allowed. In addition, the administrator can assign a set of area affinities for each of the one or more users 102, and wherein the area affinities are areas in which the one or more users 102 are only allowed to roam.

In accordance with an embodiment, for example, in a “User-Assert engine” application of the software of the video surveillance system 220, 230, an application programming interface (API) call to an identify and access management (IAM) solution 210 can include a request to perform an area enforcement. For example, the identify and access management solution 210 can be configured to perform area enforcement, and can provide, for example, username and source video surveillance camera unique identity (for example, a camera label or MAC address depending on the type of video surveillance system 220, 230).

In accordance with an embodiment, the identify and access management solution 210 can perform area enforcement for a particular user 102 by responding “YES” or “NO” to the requesting video surveillance system 220, 230. For example, if the identify and access management solution 210 responds with a “YES”, the user 102 can be allowed in a first zone (Zone-A) 240 or a second zone (Zone-B) 242, and no alert is necessary. Alternatively, if the response by the identify and access management solution 210 is “NO” for the user 104, an alert can be sent, for example, to an administrator or security personnel that a breach of a third zone (Zone-C) 244 has occurred and/or the user 102 can be added to an area map 300 as an unauthorized user 104.

FIG. 3 is an illustration of an automated instantaneous area map (or heat map) 300 in accordance with an exemplary embodiment. In accordance with an embodiment, the method and system 100 can provide automated instantaneous (i.e., snapshot) area map 300. As shown in FIG. 3, the area map 300 can include a plurality of zones (or areas) 310, 312, 314, 316 that include one or more users 102, 104. The area map 300 can provide an administrator a tool that the visibility for the administrator to see which of the one or more users 102 are in which area or zone 130, 132 at any time. In addition, the area map 300 can be a heat map that includes an alert or indication 320, for example, via a change in color of a user 104, when the user or users 104 have entered into an unauthorized zone 312, 316.

In accordance with an embodiment, the area map 300 can be a heat map that can be used to visualize and display a geographic distribution of the one or more users 102, 104, and upon one or more of the users 104 entering an unauthorized zone 312, 316, the heat map can represent different users 102, 104 via, for example, different colors. For example, one or more users 102 in an allowed area or zone 310, 312 can be a first color (for example, green), and one or more users 104 in an unauthorized user 312, 316 can be a second color (for example, red) to help administrators and the like to understand the locations of the one or more users 102, 104.

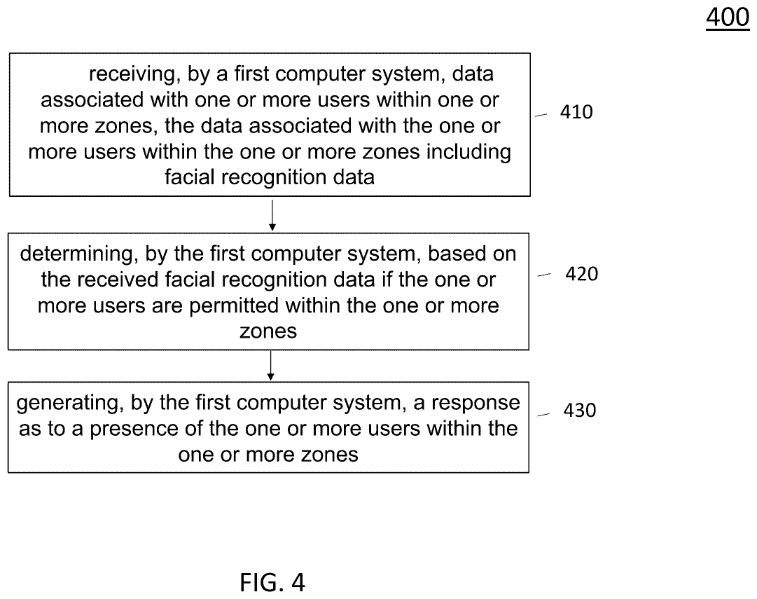

FIG. 4 is a flowchart 400 for a method for generating a virtual security wall through a seamless zone and area-based access control system that provides physical-area granularity on access control for a video surveillance system in accordance with an embodiment. As shown in FIG. 4, the method includes receiving 410, by a first computer system 120, data associated with one or more users within one or more zones, the data associated with the one or more users within the one or more zones including facial recognition data; determining 420, by the first computer system 120, based on the received facial recognition data if the one or more users are permitted within the one or more zones; and generating 430, by the first computer system 120, a response as to a presence of the one or more users within the one or more zones.

In accordance with an embodiment, the method further includes receiving, by the first computer system 120, the data associated with one or more users 102 within one or more zones from a cloud computing network 122.

In accordance with an embodiment, the method further includes receiving, by the first computer system 120, the data associated with one or more users within one or more zones from an edge device.

In accordance with another embodiment, the method further includes sending, by the first computer system 120, an alert to a second computer system 112 that the presence of the one or more users 102 within the one or more zones is not permitted.

In accordance with an embodiment, the method further includes registering, with the first computer system 120, one or more of the one or more user 102; and assigning, by the first computer system 120, one or more of the one or more zones in which the one or more of the one or more users 102 are permitted.

In accordance with another embodiment, the method further includes assigning, by the first computer system 120, no restrictions for users to one or more of the one or more zones.

In accordance with an embodiment, wherein the data associated with the one or more users 102 within the one or more zones is from one or more video surveillance cameras 110.

In accordance with another embodiment, the method further includes generating, by the first computer system 120, a heat map 300 of the one or more users 102, 104 within the one or more zones 310, 320, 330, 340, the heat map 300 including a location of the one or more users 102, 104 within the one or more zones 310, 320, 330, 340.

In accordance with an embodiment, the method further includes receiving, by the first computer system 120, the data associated with the one or more users 102, 104 within the one or more zones from a location having at least one registered user 102, the at least one registered user being an employee of a company or business; and classifying, by the first computer system 120, a user that is not registered with the first computer system as a non-employee. The method further includes auto-populating, by the first computer system 120, one or more of the one or more zones that each of the or more users are permitted; and receiving, by the first computer system 120, one or more zones of the one or more zones in which only a portion of the one or more users 102 are permitted.

In accordance with another embodiment, the method further includes receiving, by the first computer system 120, in an application programming interface call from a video surveillance camera 110, a request to perform an area enforcement of the one or more zones, and a unique identity of the video surveillance camera. For example, the unique identity of the video surveillance camera is a media access control (MAC) address.

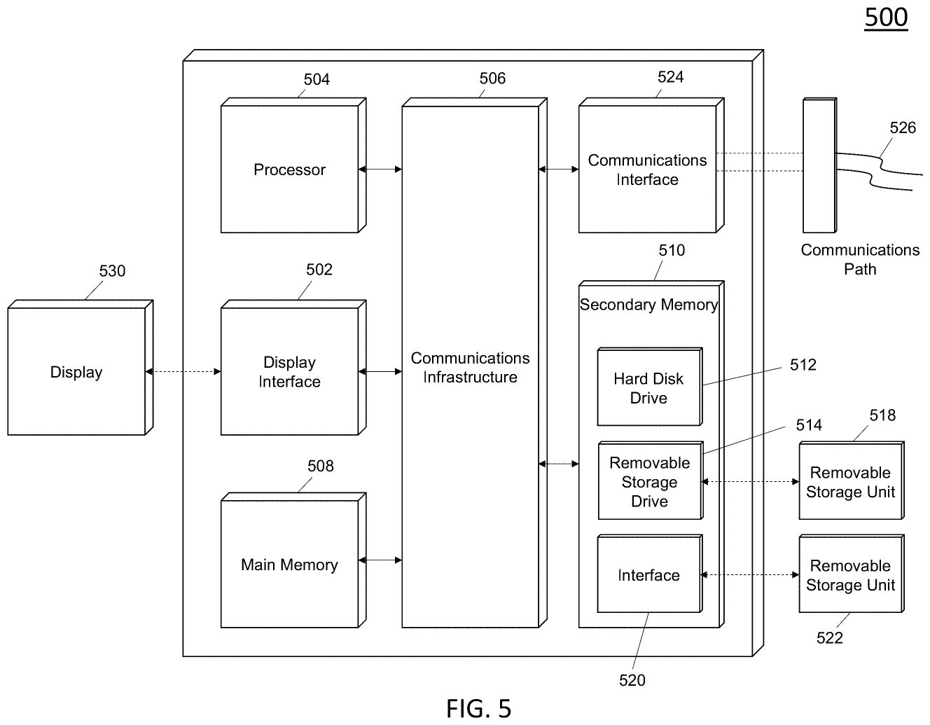

FIG. 5 illustrates a representative computer system 500 in which embodiments of the present disclosure, or portions thereof, may be implemented as computer-readable code executed on hardware. For example, the one or more computer systems 110, 112, 120, 212, 234 associated with the method and system for area-based access control as disclosed herein may be implemented in whole or in part by a computer system 500 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this representative computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 504 may be processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof.

Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 1-4, as discussed herein. Accordingly, such computer programs may represent controllers of the computer system 500. Where the present disclosure is implemented using software executed on hardware, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software executed on hardware, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for area-based access control, the method comprising:
receiving, by a first computer system, data associated with one or more users within one or more zones, the data associated with the one or more users within the one or more zones including facial recognition data;
determining, by the first computer system, based on the received facial recognition data if the one or more users are permitted within the one or more zones; and
generating, by the first computer system, a response as to a presence of the one or more users within the one or more zones.

2. The method according to claim 1, further comprising:
receiving, by the first computer system, the data associated with one or more users within one or more zones from a cloud computing network.

3. The method according to claim 1, further comprising:
receiving, by the first computer system, the data associated with one or more users within one or more zones from an edge device.

4. The method according to claim 1, further comprising:
sending, by the first computer system, an alert to a second computer system that the presence of the one or more users within the one or more zones is not permitted.

5. The method according to claim 1, further comprising:
registering, with the first computer system, one or more of the one or more user; and
assigning, by the first computer system, one or more of the one or more zones in which the one or more of the one or more users are permitted.

6. The method according to claim 1, further comprising:
assigning, by the first computer system, no restrictions for users to one or more of the one or more zones.

7. The method according to claim 1, wherein the data associated with the one or more users within the one or more zones is from one or more video surveillance cameras.

8. The method according to claim 1, further comprising:
generating, by the first computer system, a heat map of the one or more users within the one or more zones, the heat map including a location of the one or more users within the one or more zones.

9. The method according to claim 1, further comprising:
receiving, by the first computer system, the data associated with the one or more users within the one or more zones from a location having at least one registered user, the at least one registered user being an employee of a company or business; and
classifying, by the first computer system, a user that is not registered with the first computer system as a non-employee.

10. The method according to claim 9, further comprising:
auto-populating, by the first computer system, one or more of the one or more zones that each of the or more users are permitted; and
receiving, by the first computer system, one or more zones of the one or more zones in which only some of the one or more users are permitted.

11. The method according to claim 1, further comprising:
receiving, by the first computer system, in an application programming interface call from a video surveillance camera, a request to perform an area enforcement of the one or more zones, and a unique identity of the video surveillance camera.

12. The method according to claim 11, wherein the unique identity of the video surveillance camera is a media access control (MAC) address.

13. A non-transitory computer-readable storage medium having program instructions embodied therewith, the program instructions executable by a computer to cause the computer to perform a process for area-based access control, comprising:
receiving data associated with one or more users within one or more zones, the data associated with the one or more users within the one or more zones including facial recognition data;
determining based on the received facial recognition data if the one or more users are permitted within the one or more zones; and
generating a response as to a presence of the one or more users within the one or more zones.

14. The non-transitory computer-readable storage medium according to claim 13, further comprising:
receiving the data associated with one or more users within one or more zones from a cloud computing network.

15. The non-transitory computer-readable storage medium according to claim 13, further comprising:
receiving the data associated with one or more users within one or more zones from an edge device.

16. The non-transitory computer-readable storage medium according to claim 13, further comprising:
sending an alert to a computer system that the presence of the one or more users within the one or more zones is not permitted.

17. The non-transitory computer-readable storage medium according to claim 13, further comprising:
registering one or more of the one or more user; and
assigning one or more of the one or more zones in which the one or more of the one or more users are permitted.

18. An identify and management device comprising:
a processor configured to:
receive data associated with one or more users within one or more zones, the data associated with the one or more users within the one or more zones including facial recognition data;
determine based on the received facial recognition data if the one or more users are permitted within the one or more zones; and
generate a response as to a presence of the one or more users within the one or more zones.

19. The identify and management device according to claim 18, wherein the processor is configured to:
receive the data associated with one or more users within one or more zones from a cloud computing network.

20. The identify and management device according to claim 18, wherein the processor is configured to:
receive the data associated with one or more users within one or more zones from an edge device.
